(19) United States
(12) Patent Application Publication
(10) Pub. No.: US 2007/0034560 A1
(43) Pub. Date: Feb. 15, 2007

(54) Drain valve alignment system for filter assembly

(76) Inventors: Leon P. Janik, Suffield, CT (US); Michael J. Williams, Glastonbury, CT (US)

Correspondence Address: ALIX YALE & RISTAS LLP, 750 MAIN STREET, SUITE 1400, HARTFORD, CT, 06103, US

(21) Appl. No.: 11/200,325

(22) Filed: Aug. 9, 2005

(51) Int. Cl. F16K 24/00; B01D 35/00

(52) U.S. Cl. 210/248; 137/588

(57) ABSTRACT

The present invention discloses a drain assembly for securement over the sump opening of a filter cartridge that allows service personnel to drain water from the cartridge sump where access from directly beneath the cartridge is obstructed. The drain assembly includes a drain extension that effectively shifts the drain outlet from directly beneath the cartridge to a position radially outward of the cartridge housing side wall. The filter cartridge and drain assembly include locating features which cooperate to define an installed orientation of the drain extension and outlet relative to the cartridge housing. Defining the installed orientation of the drain assembly relative to the housing ensures that the drain valve member and outlet are accessible to service personnel while the cartridge is installed on the vehicle.

### BACKGROUND OF THE INVENTION

1. Field of the Invention

The present invention relates generally to fuel filters employed in connection with internal combustion engines and, more particularly, to removal of water separated from the fuel supply that has accumulated in the cartridge housing.

2. Description of the Related Prior Art

Fuel filter systems commonly employ a disposable filter cartridge that is replaced at pre-established intervals of filter usage. The replaceable cartridge is conventionally secured to a base that defines inlet and outlet connections between the cartridge and the fuel supply system. The replaceable fuel filter cartridges are configured to remove foreign particles and separate water from the fuel supply. Water separated from the fuel accumulates in a sump defined by the filter cartridge housing. The cartridge is typically suspended from a base so that fuel is delivered and retrieved from the cartridge through a fluid circulation opening at the top of the cartridge and separated water accumulates in a sump at the bottom of the cartridge. A drain cock permitting periodic drainage of accumulated water is provided at a sump opening axially opposed to the fluid circulation opening. Water must periodically be drained from the cartridge sump to avoid excess accumulation. Typically, this involves loosening the drain cock and releasing fluid from the cartridge sump until no water is present in the effluent.

### SUMMARY OF THE INVENTION

The size, shape, installation and function of fuel filtration systems are frequently subject to spatial constraints. The present invention discloses a drain assembly for securement over the sump opening of a filter cartridge that allows service personnel to drain water from the cartridge sump where access from directly beneath the cartridge is obstructed. The drain assembly includes a drain extension that effectively shifts the drain outlet from directly beneath the cartridge to a position radially outward of the cartridge housing side wall. The filter cartridge and drain assembly include locating features which cooperate to define an installed orientation of the drain extension and outlet relative to the cartridge housing. Defining the installed orientation of the drain assembly relative to the housing ensures that the drain valve member and outlet are accessible to service personnel while the cartridge is installed on the vehicle.

### BRIEF DESCRIPTION OF THE DRAWINGS

FIG. 1 is a sectional view through a typical water separating fuel filter cartridge compatible with the present invention;

FIG. 2 is a sectional view through the housing lower portion and drain assembly illustrating an embodiment of the drain valve alignment system for filter assembly according to aspects of the present invention;

FIG. 3 is a bottom view of the cartridge housing and drain assembly of FIG. 2; and

FIG. 4 is a bottom view of an embodiment of a filter cartridge illustrating a pattern of detents in relation to radially outwardly displaced portions of the roll seam shoulder of the cartridge according to aspects of the present invention.

### DETAILED DESCRIPTION OF THE PREFERRED EMBODIMENT

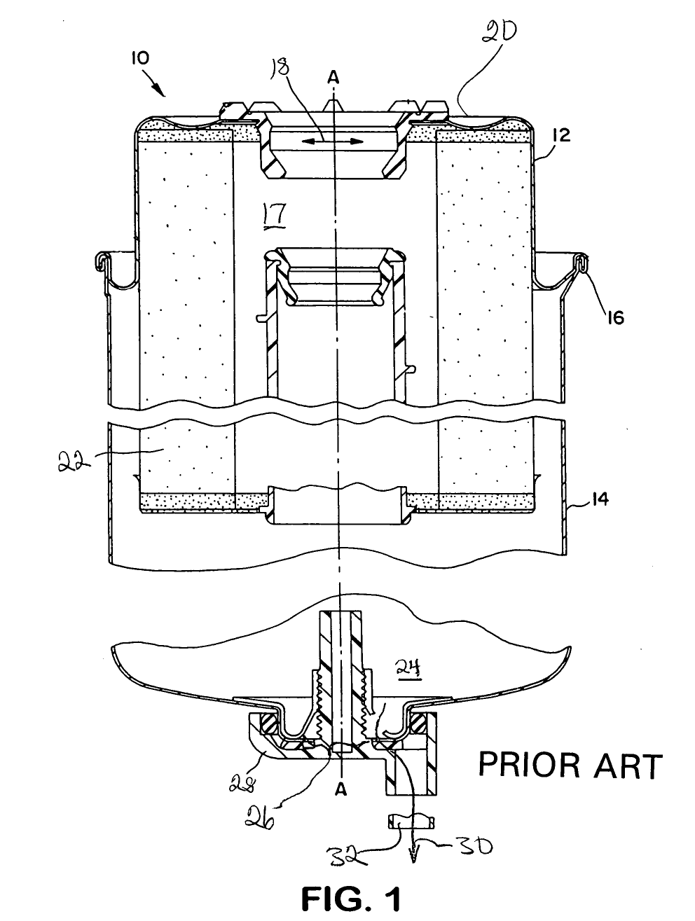

The present invention relates to a specialized drain assembly compatible with water separating filter cartridges such as that illustrated in FIG. 1. In the cartridge 10 illustrated in FIG. 1, upper and lower housing sections 12, 14 are joined at a circumferential roll seam 16 to define a generally cylindrical interior space 17. The upper housing section 12 defines a fluid circulation opening 18 at a first axial end 20 of the cartridge housing. In a typical arrangement coaxial fluid inlet and outlet conduits (not shown) are received through the fluid circulation opening 18 to supply fuel to and receive filtrate from the filter cartridge 10. A filter element 22 is supported in the interior space 17 such that fuel circulates through the filter media.

The filter media is configured and treated to remove particulates from the fuel and separate water suspended in the fuel. Water separated from the fuel falls to the bottom of the cartridge housing because it has a greater specific gravity than the fuel. Water accumulates in a sump 24 defined by the lower housing section 14. The lower housing section 14 defines a sump opening 26 axially opposite the fluid circulation opening 18. The sump opening 26 is typically closed by a drain cock 28 as shown in FIG. 1. When the drain cock 28 is loosened a fluid flow passage 30 opens between the sump 24 and a drain passage 32 in the drain cock 28. Excess water is drained from the sump and the drain cock is retightened. The cartridge and drain cock configuration illustrated in FIG. 1 assume service personnel have access to the bottom of the filter cartridge and there is sufficient space to carry out the draining procedure.

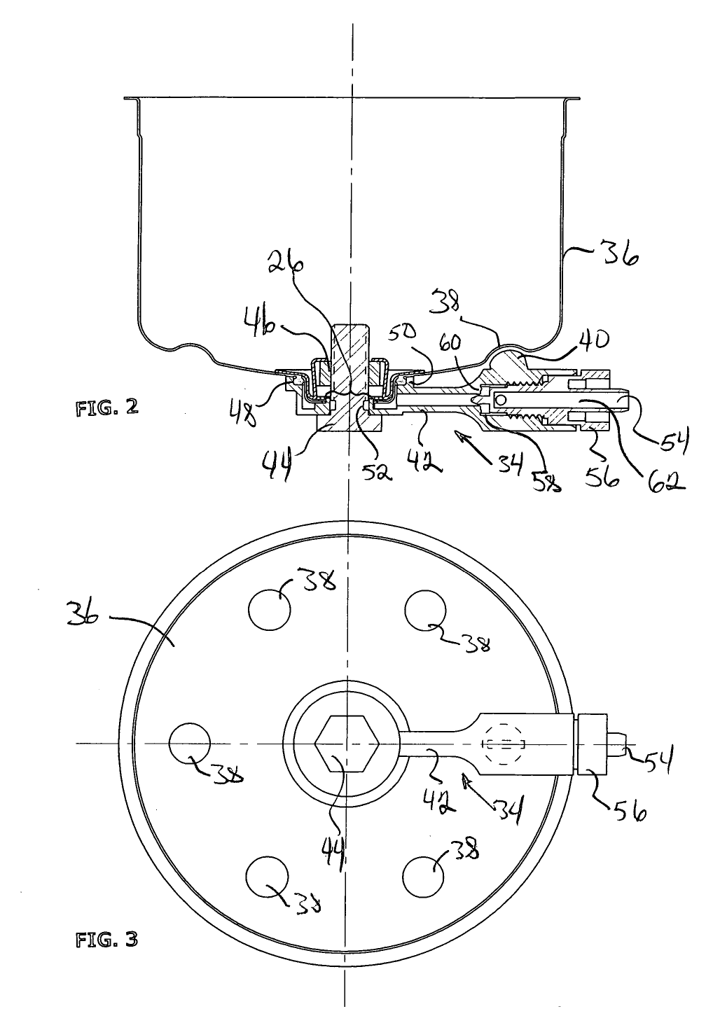

The present invention describes a drain assembly that effectively offsets the sump drain passage from directly beneath the cartridge to a position radially outward of the cartridge housing lower section. A drain valve assembly 34 according to aspects of the present invention allows service personnel to drain accumulated water from the filter cartridge in installations where space below the cartridge is limited. As shown in FIGS. 2 and 3, the cartridge housing lower portion 36 and drain assembly 34 are provided with interactive locating features 38, 40 that define an installed orientation of the drain assembly relative to the cartridge housing. It should be apparent that since access from beneath the installed cartridge is obstructed, the drain assembly will necessarily be installed to the cartridge housing before the cartridge is installed in the vehicle. Given the spatial constraints, it is important that the drain outlet be positioned where it is accessible to service personnel after the cartridge is installed.

An embodiment of the drain valve alignment system for filter assembly achieves this goal by modifying the cartridge housing lower section 36 with a circumferential arrangement of dimples 38. A projection 40 from the drain extension 42 is configured to fit into a selected dimple 38, thereby defining an installed orientation of the drain assembly 34 relative to the cartridge housing lower section 36. A threaded bolt 44 passes through one end of the drain extension 42 to engage a threaded bore 46 inside the cartridge lower section 36. Tightening the bolt 44 brings the drain extension 42 into sealed engagement with the outside of the cartridge housing. As best shown in FIG. 2, an O-ring seal 48 seated in a lip 50 of the drain extension 42 surrounding the sump opening 26 is compressed between the drain extension 42 and the cartridge outside surface. A second seal 52 is seated in a groove around the neck of the bolt 44 to seal the bolt relative to the drain extension 42. Tightening the bolt 44 also brings the projecting alignment feature 40 on the drain extension 42 into engagement with a selected one of the dimple alignment features 38 on the cartridge housing lower section 36. This inter-fitting relationship between the cartridge and drain assembly alignment features 38, 40 maintains the drain extension 42 in the selected orientation relative to the cartridge during and after cartridge installation. The cartridge housing may include instructions or indications printed on the outside of the cartridge indicating the proper installed orientation for the drain assembly for a given filter application.

As best seen in FIGS. 2 and 3, the drain assembly 34 effectively offsets the drain outlet 54 and valve member 56 to a position radially outward of the cartridge housing lower section 36. This installed position allows service personnel to access the valve member 56 and outlet 54. The valve member 56 is threadably engaged with the drain extension 42 such that rotation of the valve member 56 in a first direction separates a seal 58 carried by the valve member 56 from a seat 60 in the drain extension 42. Fluid in the sump flows around the seal and into a drain passage 62 defined by the valve member 56. Counter rotation of the valve member 56 brings the seal 58 back into engagement with its seat 60 closing off the drain passage 62. While a particular valve arrangement is illustrated, numerous valves suitable for this application may occur to one skilled in the art and are intended to be encompassed by the appended claims.

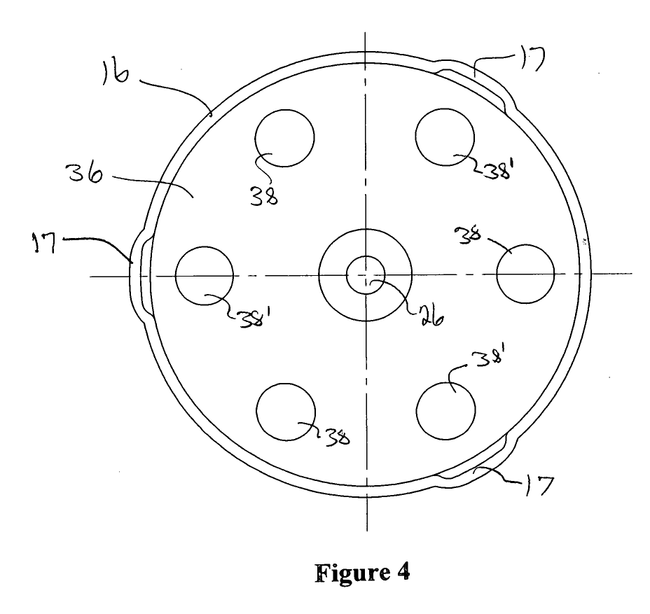

FIG. 4 illustrates a further embodiment of a filter cartridge incorporating a pattern of dimples 38 according to aspects of the present invention. The filter cartridge also includes three tabs 17 formed from radially outwardly displaced portions of the roll seam 16 that joins the upper and lower shell sections of the filter cartridge. The tabs 17 are configured to be engaged with a bayonet-type fixture on a filter base (not shown) to secure the filter cartridge to the base. In an alternative base configuration, the tabs 17 and adjacent roll seam portions are engaged by a threaded collar to secure the cartridge to the base (also not shown).

As shown in the embodiment of FIG. 4, the dimples 38 form a pattern of six equiangularly spaced hemispherical dimples radially spaced from the sump opening 26. It will be understood that the dimples 38, however arranged, have a fixed relationship with the tabs 17 formed in the cartridge roll seam 16. In the illustrated embodiment, three of the dimples 38′ are angularly aligned with the three tabs 17. Alternative tab configurations, alternative dimple patterns and alternative alignments between the tabs and dimples are possible and intended to be encompassed by the present invention. In particular, while a symmetrical arrangement of tabs in which the tabs are equiangularly displaced and of equal size and shape is disclosed, an asymmetrical tab configuration could be employed to permit only a single installed orientation of the cartridge relative to a base. In such an arrangement, a drain assembly 34 installed to the cartridge of FIG. 4 will have a pre-determined angular position relative to the base. This is one example of how the proper orientation of the cartridge relative to the base and the drain assembly relative to the installed cartridge may be determined using an embodiment of the drain valve alignment system according to the present invention.

The drain assembly 34 comprises the drain extension 42, valve member 56 and a fastener (bolt 44) for securing the drain extension 42 to the cartridge housing. The drain extension 42 and valve member 56 will typically be molded from plastics such as glass filled nylon. The fastener may be metal or plastic.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A filter cartridge comprising:
a generally cylindrical housing having an axis and extending between axially spaced first and second ends to define an interior space, said first end defining a fluid circulation opening, and said second end defining a sump opening, said second end including at least one detent radially spaced from said sump opening; and
a filter element supported in said interior space intermediate said fluid circulation opening and said sump opening to separate water from a flow of fuel delivered to said interior space through said fluid circulation opening, said water collecting in said housing adjacent said sump opening.

2. The filter cartridge of claim 1, wherein said at least one detent comprises a pattern of detents radially equidistant from said sump opening.

3. The filter cartridge of claim 1, wherein said at least one detent comprises a plurality of equiangularly spaced apart detents radially equidistant from said sump opening.

4. The filter cartridge of claim 1, wherein at least one detent comprises a pattern of six discrete detents equiangularly spaced apart and radially equidistant from said sump opening.

5. The filter cartridge of claim 1, wherein said at least one detent comprises a plurality of detents arranged about said sump opening.

6. The filter cartridge of claim 1, wherein said housing includes a peripheral roll seam deformed into a plurality of retention tabs and said at least one detent has a fixed angular relationship to said plurality of retention tabs.

7. The filter cartridge of claim 6, wherein said at least one detent comprises a plurality of detents and said plurality of retention tabs comprises at least one retention tab angularly aligned with one of said plurality of detents.

8. A filter cartridge comprising:
a generally cylindrical housing having an axis and extending between axially spaced ends to define an interior space, a fluid circulation opening at a first axial end and a sump opening at a second axial end, said second axial end including a plurality of angularly spaced first locating features;
a filter element supported in said interior space intermediate said fluid circulation opening and said sump opening to separate water from a flow of fuel delivered to said interior space through said fluid circulation opening, said water collecting in said housing adjacent said sump opening; and
a drain assembly engaged to said sump opening, said drain assembly including:
a drain body defining a fluid flow passage generally perpendicular to said axis, said drain body including a second locating feature complementary to said first locating features;
a fastener extending through said drain assembly to attach said drain assembly to said housing second axial end over said sump opening with said fluid flow passage in communication with said sump opening and said second locating feature interfitting with a selected first engagement feature to define an installed orientation of said drain assembly relative to said housing; and
a valve arranged to selectively control fluid flow through said fluid flow passage.

9. The filter cartridge of claim 8, wherein said first locating features comprise a circumferential pattern of concave dimples in said second end and said second locating feature is a protrusion configured to penetrate said selected first engagement feature.

10. The filter cartridge of claim 8, wherein said cartridge has a radius extending from said axis to a side wall connecting said first and second ends and said fluid flow passage extends radially from said sump opening to an outlet positioned radially outwardly of said side wall.

11. The filter cartridge of claim 8, wherein said drain valve assembly includes a seal compressed between said drain body and said cartridge second end radially outward of said sump opening.

12. The filter cartridge of claim 8, wherein said valve includes a valve member threadably engaged with said valve body such that rotation of said valve member relative to said drain body in a first direction separates a seal carried by said valve member from a seat on said drain body to open said fluid flow passage and rotation of said valve member in a second direction relative to said drain body compresses said seal against said seat to close said fluid flow passage.

13. The filter cartridge of claim 8, wherein said fastener comprises a threaded bolt which penetrates said sump opening to engage a complementary threaded bore inside said housing.

14. A filter cartridge comprising:
a housing extending between spaced first and second ends to define an interior space, a fluid circulation opening at said first end and a sump opening at said second end, said second end including a first locating feature radially spaced from said sump opening;
a drain extension defining a drain passage extending radially away from said sump opening, said drain extension including a second locating feature complementary to said first locating feature;
a fastener securing said drain extension over said sump opening with said drain passage in communication with said sump opening and said second locating feature interfitting with said first locating feature to define an installed orientation of said drain extension relative to said housing.

15. The filter cartridge of claim 14, comprising a valve arranged to selectively control fluid flow through said drain passage.

16. The filter cartridge of claim 15, wherein said valve includes a valve member threadably engaged with said drain extension such that rotation of said valve member in a first direction separates a seal carried by said valve member from a seat to open said drain passage and rotation of said valve member in a second direction compresses said seal against said seat to close said drain passage.

17. The filter cartridge of claim 14, wherein said first locating feature comprises a concave dimple and said second locating feature comprises a protrusion configured to penetrate said first locating feature when said drain extension is secured to said housing.

18. The filter cartridge of claim 16, wherein said housing has a radius extending from a longitudinal axis to a side wall connecting said first and second ends and said drain passage extends through said valve member to an outlet radially outward of said side wall.

19. The filter cartridge of claim 14, wherein said first locating feature comprises a plurality angularly spaced first locating features, said second locating feature being selectively engageable with any one of said plurality of first locating features.

20. The filter cartridge of claim 14, wherein said first locating feature comprises a plurality of equiangularly spaced substantially identical concave dimples surrounding said sump opening.

21. The filter cartridge of claim 14, comprising a seal compressed between said drain extension and said second end radially outward of said sump opening.

22. The filter cartridge of claim 14, wherein said fastener carries a fastener seal that sealingly engages said drain extension.
